(19) United States
(12) Patent Application Publication
(10) Pub. No.: US 2020/0143765 A1
(43) Pub. Date: May 7, 2020

(54) DISPLAY DRIVING METHOD, DISPLAY DRIVING DEVICE AND DISPLAY DEVICE

(71) Applicants: CHONGQING ADVANCE DISPLAY TECHNOLOGY RESEARCH, Chongqing (CN); Chongqing HKC Optoelectronics Technology Co., Ltd., Chongqing (CN)

(72) Inventor: Wenxin Li, Chongqing (CN)

(21) Appl. No.: 16/454,095

(22) Filed: Jun. 27, 2019

Related U.S. Application Data
(63) Continuation of application No. PCT/CN2018/115122, filed on Nov. 13, 2018.

(30) Foreign Application Priority Data
Nov. 5, 2018 (CN) 201811309921.0

(51) Int. Cl. G09G 3/36; G09G 3/3266; G09G 3/3275

(52) U.S. Cl. CPC G09G 3/3677; G09G 3/3614; G09G 3/3688; G09G 2320/0233; G09G 3/3275; G09G 2310/0251; G09G 2310/08; G09G 3/3266

(57) ABSTRACT

This application discloses a display driving method, a display driving device and a display device, and a precharge will be conducted for display pixels on the signal line of preset row in accordance with preset charge data at the time of frame scanning; then charge and precharge will be conducted for the display pixels on the signal line of the row.

### CROSS REFERENCE TO RELATED APPLICATIONS

The present application is a Continuation Application of PCT Application No. PCT/CN2018/115122 filed on Nov. 13, 2018, which claims the benefit of Chinese Patent Application No. 201811309921.0, filed on Nov. 5, 2018, which is incorporated herein by reference in its entirety.

### FIELD OF THE DISCLOSURE

This application relates to the field of display technology, and particularly, to a display driving method, a display driving device and a display device.

### BACKGROUND OF THE DISCLOSURE

Display device such as TFT-LCD (Thin Film Transistor Liquid Crystal Display) has become indispensable for video products. As big size and high resolution are required for display device, there are more and more display drive circuits, and when the scanning time for one frame is fixed, display pixels will be charged beforehand via precharge technology to ensure the charge time for display pixels on signal line of each row.

However, the precharge cannot be realized for display pixels of signal line of each row via the existing precharge technology, which needs to be improved.

### SUMMARY OF THE DISCLOSURE

The embodiment of this application provides a display driving method, a display driving device and a display device to solve the problem that the precharge cannot be realized for display pixels of signal line of each row in the process of display driving via existing technology.

The embodiment of this application provides a display driving method comprising the steps of:

acquiring preset charge data at the start of frame scanning;

conducting precharge for display pixels on preset row signal line in accordance with acquired preset charge data; and

successively charging the display pixels on all the row signal lines after the precharge for the display pixels on the preset row signal line is completed, and precharging the display pixels on the signal line of the row spaced apart from current row signal line by preset rows while charging the display pixels on the signal line of current row.

The embodiment of this application also provides a display driving device comprising:

a data obtaining module for obtaining preset charge data at the start of frame scanning;

a precharge control module for precharging display pixels on preset row signal line in accordance with acquired preset charge data; and

a charge control module for successively charging the display pixels on all the row signal lines after the precharge for preset row signal line is completed, and precharging the display pixels on the signal line of the row spaced apart from current row signal line by preset rows while charging the display pixels on the signal line of current row.

The embodiment of this application also provides a display device comprising a display unit and a display driving device for driving the display unit to light up; the display driving device comprising a time sequence controller, a data driving module and a scan driving module; the time sequence controller is configured as follows:

At the start of frame scanning, preset charge data will be acquired, the data driving module and the scan driving module will be controlled in accordance with acquired preset charge data, and the display pixels on preset row signal line will be precharged; after the completion of precharge for preset row signal line, the data driving module and the scan driving module will be controlled, and the display pixels on all the row signal line will be charged successively; and the display pixels on row signal line spaced apart from current row signal line by preset rows will be precharged while the display pixels on signal line of current row will be charged.

In the embodiment of the application, charge data is prestored; at the start of frame scanning, the display pixels on row signal line of the first row or the first few rows will be precharged by means of the prestored charge data to ensure that the display pixels on the row signal line of each row can be precharged, thus ensuring the charge time for display pixels on the row signal line of each row, i.e. achieving uniform display of screen.

### BRIEF DESCRIPTION OF THE DRAWINGS

FIG. 1 is a schematic structure diagram of the display device of an embodiment of this application;

FIG. 2 is a schematic flow diagram of the display driving method of an embodiment of this application;

FIG. 3 is a schematic flow diagram of the display driving method of another embodiment of this application;

FIG. 4 is a schematic flow diagram showing the details of step S12 in FIG. 2;

FIG. 5 is a schematic signal waveform diagram of the case that charge control is realized in the display device of an embodiment of this application;

FIG. 6 is a schematic function block diagram of the display driving device in an embodiment of this application.

### LABELS ILLUSTRATION FOR DRAWINGS

TABLE 1

| label | name | label | name |
|---|---|---|---|
| base plate | 10 | drive controller | 11 |
| display zone | 101 | row driving module | 12 |
| non display zone | 102 | data driving module | 13 |
| data obtaining module | 110 | precharge control module | 120 |
| charge control module | 130 | | |

### DETAILED DESCRIPTION OF THE EMBODIMENTS

To better understand the foregoing technical solution, a more detailed description will be given hereinafter on the exemplary embodiments of this disclosure by referring to attached drawings. Although the exemplary embodiments of this disclosure are shown in figures, it should be understand that this disclosure can be realized in various forms and shall not be limited to the embodiments explained herein. On the contrary, these embodiments are provided to enable a more thorough understanding of this disclosure and a complete convey of the scope of this disclosure to those in the art.

It needs to be explained that if there is any indication on direction (e.g., up, down, left, right, front, back . . . ) in the embodiments of this application, it will be used only for explaining the relative position relationship between components, movement condition, etc. under a specific posture (as shown by figures); if the specific posture changes, the indication on direction will also change accordingly.

Additionally, if there is a description on ‘1st’, ‘2nd’ etc. in the embodiments of this application, the description of the ‘1st’, ‘2nd’ etc. shall be regarded only as descriptive purpose rather than an implication of its relative importance or an implication of the number of indicated technical features. Thus, a feature defined by ‘1st’, ‘2nd’ can explicitly or implicitly include at least one feature. Moreover, the technical solution of each embodiment can be combined with each other on the condition that it can be realized by ordinary artisans concerned; if the combination of technical solution contradict each other or cannot be realized, it shall be regarded that the combination of such solution does not exist, nor is it in the protection scope of the claims of this application.

To solve the problem that the existing display driving solution cannot satisfy the requirement on the big size and high resolution of display device, the embodiment of this application provides a new display driving solution, i.e., outputting corresponding gamma signal according to different driving position in the process of display driving to ensure the charge effect of all the display pixels of display device and realize uniform brightness of display device.

To facilitate the understanding of the embodiment of this application, a brief introduction will be made on the driving principle of the display device of an embodiment before describing the concrete embodiment of this application.

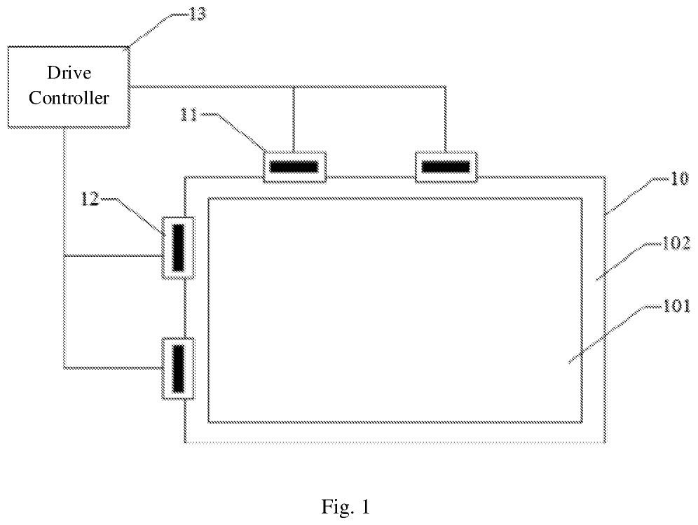

Refer to FIG. 1 which is a schematic structure diagram of a display device of an embodiment of this application. The display device comprises for instance, a liquid crystal display device and an OLED (Organic Light-Emitting Diode) display device which can also be referred to as ‘organic electroluminesence display device’. The display device comprises a base plate 10 and a display driving device 11. Specifically,

On the base plate 10 form a display zone 101 and a non display zone 102; the display zone 101 comprises a plurality of display units which can be distributed in lines and columns to form a matrix; and undoubtedly, it can not only be matrix arrangement structure but other arrangement patterns. Each display unit comprises at least one display pixel.

Furthermore, in the display zone 101 also form a signal circuit and a switch device intersecting each other; the signal circuit can specifically comprise a 1st signal line and a 2nd signal line electrically connected with the switch device; the switch device will be started when the scan driving signal on the 1st signal line is received, and at this time the display pixels will receive data signal from the 2nd signal line via the started switch device and will be lighted up according to data signal. Specifically, the switch device can include not only TFT (Thin Film Transistor) but for instance, field effect transistor, triode etc. The 1st signal line and the 2nd signal line can also be referred to as scanning line and data line.

The display driving device can specifically comprise a drive controller 11, a scan driving module 12 and a data driving module 13, wherein the drive controller 11 outputs drive control signal to cause the scan driving module 12 and the data driving module 13 to output corresponding drive signal to drive display pixels to work. Specifically, the scan driving module 12 outputs scan driving signal row by row; if the display pixels of current row receives the scan driving signal, the corresponding switch device will start to work. The display pixels of current row will receive the data signal outputted by the data driving module 13 via the started switch device, and the data signal will be transmitted to the display pixels of current row via the started switch device to charge the display pixels of current row and drive the display pixels of current row to light up. In the same manner, the display driving device will drive the display pixels row by row or every two rows until completing all the rows to complete the update of one frame.

The display driving device of the embodiment of this application adopts precharge technology, i.e., causing the row driving module 12 to output the row driving signal to the signal line of another row (hereinafter referred to as ‘row signal line for precharge’) while outputting the row driving signal to the signal line of current row, and thereby both the switch device on the signal line of current row and the switch device on the row signal line for precharge can be started to work, and the data signal will be transmitted to the display pixels on the signal line of current row and the display pixels on the row signal line for precharge via the started switch device. At this time, the data signal will charge the display pixels on the signal line of current row, and will drive the display pixels of current row to light up when the charge voltage reaches the driving voltage of display pixels. Meanwhile, the rest data signal will precharge the display pixels on the row signal line for precharge, i.e., the voltage on the display pixels on the row signal line for precharge reaches a certain value (but not enough to drive the display pixels of current row to light up); when the scan driving module 12 scans to the row signal line for precharge, as long as the voltage signal with less amplitude is provided, the charge voltage on the row signal line for precharge can rapidly reach the voltage capable of driving display pixels to light up, and thus can achieve the purpose of rapidly driving the display pixels to light up.

When the display driving device adopts precharge technology, the reaction speed of display pixels can be increased, but at the time of display driving, the first row or the first few rows of row scanning usually cannot realize precharge, leading to the poor charge effect of the display pixels on the row signal line incapable of precharge and the nonuniform display of screen.

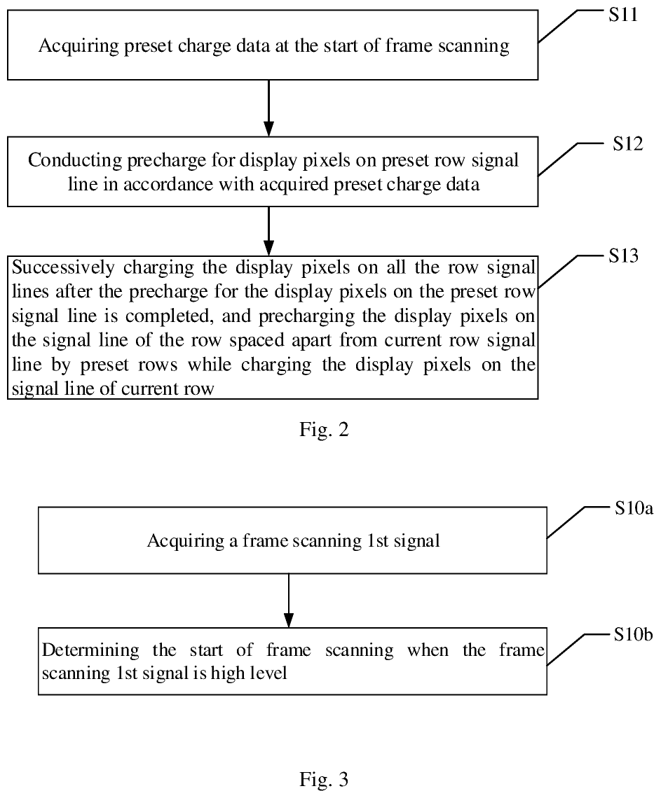

For this, refer to FIG. 2 which is a schematic flow diagram of the display driving method of an embodiment of this application. The technical solution of this application provides a new display driving method comprising the following steps of:

S11, acquiring preset charge data at the start of frame scanning;

S12, conducting precharge for display pixels on preset row signal line in accordance with acquired preset charge data; and

S13, successively charging the display pixels on all the row signal lines after the precharge for the display pixels on the preset row signal line is completed, and precharging the display pixels on the signal line of the row spaced apart from current row signal line by preset rows while charging the display pixels on the signal line of current row.

The preset charge data is stored in a drive controller 11, and at the start of frame scanning, the charge data stored in the drive controller 11 will be acquired, and the corresponding precharge signal will be outputted via the data driving module 13 in accordance with the charge data; and when the switch device on the preset row signal line is driven to start via the scan driving module 12, the precharge signal can precharge the display pixels on the preset row signal line via the started switch device.

After the completion of the precharge for the display pixels on the preset row signal line, the drive controller 11 will cause the scan driving module 12 and the data driving module 13 to conduct normal scan control and charge control. Specifically, causing the scan driving module 12 to successively output scan driving signal, and causing the data driving module 13 to output corresponding data signal to drive the display pixels on the signal line of each row to light up. Furthermore, the drive controller 11 will also conduct scanning and driving for the row signal line spaced apart from current row signal line by preset rows when causing the scan driving module 12 to conduct scanning and driving for the signal line of current row so as to drive the switch device on current row signal line and the switch device on the row signal line spaced apart from current row signal line by preset rows to work; at this time, the data signal outputted by the data driving module 13 will precharge the display pixels on the row signal line spaced apart from current row signal line by preset rows when charging the display pixels on current row signal line.

The embodiment of this application prestores charge data by which the display pixels on the row signal line of the first row or the first few rows will be precharged at the start of frame scanning, ensuring that the precharge can be realized for the display pixels on the row signal line of each line.

Furthermore, in an embodiment of this application, as shown by FIG. 3 which is a schematic flow diagram of the display driving method of another embodiment of this application. The steps before the step S11 further comprising:

step S10a, acquiring a frame scanning 1st signal; and

step S10b, determining the start of frame scanning when the frame scanning 1st signal is high level.

When the drive controller 11 controls the scan driving module 12, a frame scanning 1st signal STV1 and a frame scanning 2nd signal STV2 will be generated; the frame scanning 1st signal STV1 and a frame scanning 2nd signal STV2 will be outputted to the scan driving module 12. When the scan driving module 12 receives the frame scanning 1st signal STV1, it will determine whether the scanning of one frame starts. Specifically, in an example, when the frame scanning 1st signal STV1 is high level, it will determine that the scanning of one frame starts, and the scanning of one frame is completed, and the scanning for a new frame starts.

Further, when the scanning for one frame starts, it will execute step S11 to step S12 first, i.e., precharging the display pixels on the preset row signal line. After the completion of the charge, a normal scanning will be conducted for one frame, i.e., the scanning of row signal line will be conducted row by row or every two rows from the 1st row to charge the display pixels on the row signal line, and precharge technology will be adopted at the same time. Therefore, in the embodiment of this application, when the frame scanning 1st signal STV1 is low level, it will judge whether the frame scanning 2nd signal STV2 is high level, and if so, a normal scanning for one frame will be conducted.

Further, the number of row signal lines is relatively large, so some display device will divide all the row signal lines into a plurality of areas and conduct scan driving for the row signal lines of corresponding area by setting a plurality of scan driving modules 12. Therefore, the drive controller 11 just needs to output the frame scanning 1st signal STV1 to one of the scan driving modules 12 and output the frame scanning 2nd signal STV2 after the frame scanning 1st signal STV1 has been outputted for some time. When completing the scanning for the row signal line connected with it in accordance with frame scanning 2nd signal STV2, the scan driving module 12 will generate a control signal and send it to the next scan driving module 12 which will start to scan the connected row signal line when receiving the control signal sent by the previous scan driving module 12. In the same manner, the scanning for the row signal lines of one frame will be completed after all the scan driving modules 12 completes scanning.

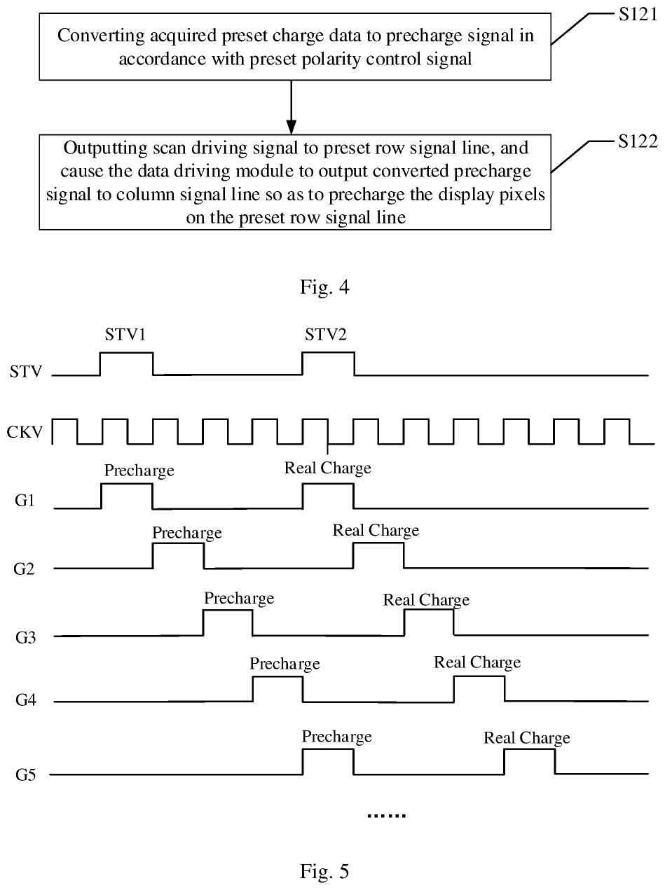

Another embodiment of this application is shown in FIG. 4 which is a schematic flow diagram of the details of the step S12 in FIG. 2. The step S12 comprises:

step S121, converting acquired preset charge data to precharge signal in accordance with preset polarity control signal; and

step S122, outputting scan driving signal to preset row signal line and outputting converted precharge signal to column signal line to precharge the display pixels on the preset row signal line.

In the display device, the charge signal outputted by the data driving module 13 comprises positive signal and negative signal. The data driving module 13 will output corresponding polarity signal in accordance with preset polarity control signal. Besides, the data driving module 13 will adopt different polarity inversion driving method according to different display characteristic. The polarity inversion driving method comprises row inversion driving, column inversion driving, frame inversion driving, dot inversion driving, etc Taking frame inversion driving as an example, if the signal polarity outputted by data driving module 13 is +−−++−− . . . at the time of current frame scanning, the signal polarity outputted by data driving module 13 is −++−−++ . . . at the time of next frame scanning.

Depending on polarity requirement, in this embodiment, when the display pixels on the preset row signal line are precharged, the acquired preset charge data will be converted to precharge signal in accordance with preset polarity control signal, i.e., converting the preset charge data to the precharge signal with the same signal polarity as that on the preset row signal line of current frame. Then, the converted precharge signal will be outputted to column signal line which precharges the display pixels on the preset row signal line via the started switch device.

The charge data will be converted to adaptive polarity signal via preset polarity control signal to ensure the precharge effect of the display pixels on preset row signal line.

Based on the foregoing embodiment, the embodiment of this application takes a display device as an example to concretely describe the display driving method. In the precharge technology adopted by the display device, the display pixels of the 5th row will be precharged while the display pixels of the 1st row is charged; and the display pixels of the 6th row will be precharged while the display pixels of the 2nd row is charged; in the same manner, the display pixels of row n+4 will be precharged while the display pixels of row n is charged. As is known from above, the precharge of the 1st row to the 4th row can be realized via the embodiment of this application.

Refer to FIG. 5 which is a schematic signal waveform diagram for realizing charge control in display device of an embodiment of this application.

The drive controller 11 outputs frame scanning 1st signal STV1 and frame scanning 2nd signal STV2, and controls the real scanning at the start of frame scanning and after the start of frame scanning.

When the frame scanning 1st signal STV1 is high level, the drive controller 11 will cause the scan driving module 12 to output the scan driving signal of 4 clock cycles, and the scan driving signal will be outputted to the row signal line of row 1 to row 4 row by row. The switch device on the row signal line of row 1 will be driven first to work via the scan driving signal; at this time, the drive controller 11 will obtain charge data and convert it to the precharge signal suiting polarity, and the data driving module 13 will output the precharge signal to the display pixels on the row signal line of row 1, and thereby the precharge for the display pixels on the row signal line of row 1 can be realized. Next, the switch device on the row signal line of row 2 will be driven to work; at this time, the precharge signal outputted by the data driving module 13 is used to realize the precharge for the display pixels on the row signal line of row 2. In the same manner, the data driving module 13 will complete the precharge for the display pixels on the row signal line of row 4 after the switch device on the row signal line of row 4 is started to work.

When the precharge for the display pixels on the signal lines of row 1 to row 4 is completed, i.e. the outputted frame scanning 2nd signal STV2 is high level, the real scanning will start. Namely, the scan driving module 12 will drive the switch device on row signal line row by row or every two rows from row 1; meanwhile the charge data outputted by data driving module 13 will charge the display pixels on row signal line via the started switch device. Besides, the scan driving signal drives the switch device on the row signal line of row 5 to work while the scan driving module 12 charges the display pixels on the row signal line of row 1, so the charge signal outputted by data driving module 13 will also precharge the display pixels on the row signal line of row 5. In the same manner, the scanning and refreshing of one frame will be completed after the charge for the display pixels on all the row signal lines is completed.

It is necessary to precharge the display pixels on the row signal lines of row 1 to row 4, so the charge data prestored in drive controller 11 comprises 4 voltage values, e.g., +10V, −3V, −3V, +10V. Undoubtedly, the prestored charge data may comprise one voltage value or two voltage values, and the acquired charge data will be converted to adaptive polarity signal in accordance with polarity control signal.

Further, if the display device has TP mode and scanning display mode, the scanning of frame screen will have to be conducted in scanning display mode, i.e., the data driving module 13 has to output data signal in scanning display mode. Therefore, if TP signal is high level in TP mode, the data driving module 13 will have to output data signal when TP signal is descend edge. If TP signal is low level in TP mode, the data driving module 13 will have to output data signal when TP signal is ascend edge.

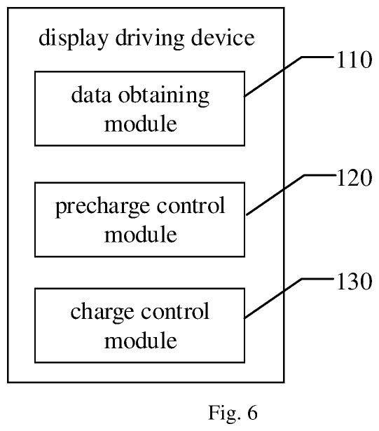

Refer to FIG. 6 which is a schematic function block diagram of the display driving device in an embodiment of this application. The display driving device comprises:

a data obtaining module 110 for obtaining preset charge data at the start of frame scanning;

a precharge control module 120 for precharging display pixels on preset row signal line in accordance with acquired preset charge data; and

a charge control module 130 for successively charging the display pixels on all the row signal lines after the precharge for preset row signal line is completed, and precharging the display pixels on the signal line of the row spaced apart from current row signal line by preset rows while charging the display pixels on the signal line of current row.

The preset charge data is stored in a drive controller 11, and at the start of frame scanning, the charge data stored in the drive controller 11 will be acquired by the data obtaining module 110, and the precharge control module 120 causes the data driving module 13 to output the corresponding precharge signal in accordance with the charge data; and the precharge control module 120 also causes the scan driving module 12 to drive the switch device on the preset row signal line to work, and at this time the precharge signal can precharge the display pixels on the preset row signal line via the started switch device.

After the completion of the precharge for the display pixels on the preset row signal line, the charge control module 130 will cause the scan driving module 12 and the data driving module 13 to conduct normal scan control and charge control. Specifically, causing the scan driving module 12 to successively output scan driving signal, and causing the data driving module 13 to output corresponding data signal to drive the display pixels on the signal line of each row to light up. Furthermore, the drive controller 130 will also conduct scanning and driving for the row signal line spaced apart from current row signal line by preset rows when causing the scan driving module 12 to conduct scanning and driving for the signal line of current row so as to drive the switch device on current row signal line and the switch device on the row signal line spaced apart from current row signal line by preset rows to work; at this time, the data signal outputted by the data driving module 13 will precharge the display pixels on the row signal line spaced apart from current row signal line by preset rows when charging the display pixels on current row signal line.

The embodiment of this application prestores charge data by which the display pixels on row signal line of the first row or the first few rows will be precharged at the start of frame scanning to ensure the precharge can be realized for display pixels on row signal line of each row, and thus ensure the charge time for display pixels on row signal line of each row, i.e. achieving uniform display of screen.

Further, the precharge control module 120 is also used to convert acquired preset charge data to precharge signal in accordance with preset polarity control signal, output scan driving signal to preset row signal line, and output converted precharge signal to column signal line so as to precharge the display pixels on the preset row signal line.

When the scan driving module 12 is controlled, a frame scanning 1st signal STV1 and a frame scanning 2nd signal STV2 will be generated; the frame scanning 1st signal STV1 and a frame scanning 2nd signal STV2 will be outputted to the scan driving module 12. When the scan driving module 12 receives the frame scanning 1st signal STV1, it will determine whether the scanning of one frame starts. Specifically, in an example, when the frame scanning 1st signal STV1 is high level, it will determine that the scanning of one frame starts, and the scanning of one frame is completed, and the scanning for a new frame starts.

Further, when the scanning for one frame starts, it will first execute the precharge for the display pixels on the preset row signal line. After the completion of the charge for display pixels on the preset row signal line, a normal scanning will be conducted for one frame, i.e., the scanning of row signal line will be conducted row by row or every two rows from the 1st row to charge the display pixels on the row signal line, and precharge technology will be adopted at the same time. Therefore, in the embodiment of this application, when the frame scanning 1st signal STV1 is low level, it will judge whether the frame scanning 2nd signal STV2 is high level, and if so, a normal scanning for one frame will be conducted.

Further, the number of row signal lines is relatively large, so some display device will divide all the row signal lines into a plurality of areas and conduct scan driving for the row signal lines of corresponding area by setting a plurality of scan driving modules 12. Therefore, we just need to output the frame scanning 1st signal STV1 to one of the scan driving modules 12 and output the frame scanning 2nd signal STV2 after the frame scanning 1st signal STV1 has been outputted for some time. When completing the scanning for the row signal line connected with it in accordance with frame scanning 2nd signal STV2, the scan driving module 12 will generate a control signal and send it to the next scan driving module 12 which will start to scan the connected row signal line when receiving the control signal sent by the previous scan driving module 12. In the same manner, the scanning for the row signal lines of one frame will be completed after all the scan driving modules 12 completes scanning.

Further, the precharge control module 120 is also used to convert acquired preset charge data to precharge signal in accordance with preset polarity control signal, output scan driving signal to preset row signal line, and output converted precharge signal to column signal line so as to precharge the display pixels on the preset row signal line.

In the display device, the charge signal outputted by the data driving module 13 comprises positive signal and negative signal. The data driving module 13 will output corresponding polarity signal in accordance with preset polarity control signal. Besides, the data driving module 13 will adopt different polarity inversion driving method according to different display characteristic. The polarity inversion driving method comprises row inversion driving, column inversion driving, frame inversion driving, dot inversion driving, etc Taking frame inversion driving as an example, if the signal polarity outputted by current frame data driving module 13 is +−−++−− . . . , the signal polarity outputted by next frame data driving module 13 is −++−−++ . . .

Depending on polarity requirement, in this embodiment, when the display pixels on the preset row signal line are precharged, the acquired preset charge data will be converted to precharge signal in accordance with preset polarity control signal, i.e., converting the preset charge data to the precharge signal with the same signal polarity as that on the preset row signal line of current frame. Then, the converted precharge signal will be outputted to column signal line which precharges the display pixels on the preset row signal line via the started switch device.

The charge data will be converted to adaptive polarity signal via preset polarity control signal to ensure the precharge effect of the display pixels on preset row signal line.

It should be explained that the display driving device in the embodiment of this application further comprises the structure of display driving device described in FIG. 1. Additionally, the control process of display driving device shown by FIG. 6 can also be realized only by the drive controller 11 in FIG. 1.

It should be noted that in claims, any reference symbols in brackets shall not constitute a restriction on claims. The word ‘comprise’ does not exclude the components or steps that have not been listed in claims. The word ‘one’ or ‘a’ prior to a component does not exclude the existence of a plurality of such components. This application can be realized by means of a hardware comprising different components and a properly-programmed computer. If a unit claim has listed some devices, some of these devices can be realized by the same hardware. The use of the word ‘1st’, ‘2nd’, ‘3rd’ etc. does not indicate any sequence. These words can be interpreted as name.

Though the preferred embodiments of this application have been described, the artisans concerned may modify and change these embodiments once they have known basic creative concept. Therefore, the claims are to be interpreted as ‘including the preferred embodiments and all the modifications and changes within the scope of claims of this application’.

It will be apparent to those skilled in the art that various modifications and variations of the present application may be made without departing from the spirit or scope of the application. If these various modifications and variations of the present application belong to the scope of the claim and equivalent technical scope, the present application is intended to comprise these modifications and variations.

What is claimed is:

1. A display driving method comprising the steps of:
acquiring preset charge data at the start of frame scanning;
conducting precharge for display pixels on preset row signal line in accordance with acquired preset charge data; and
successively charging the display pixels on all the row signal lines after the precharge for the display pixels on the preset row signal line is completed, and precharging the display pixels on the signal line of the row spaced apart from current row signal line by preset rows while charging the display pixels on the signal line of current row.

2. The display driving method according to claim 1, wherein the step of precharging the display pixels on preset row signal line in accordance with acquired preset charge data comprises:
converting acquired preset charge data to precharge signal in accordance with preset polarity control signal; and
outputting scan driving signal to preset row signal line and outputting converted precharge signal to column signal line to precharge the display pixels on the preset row signal line.

3. The display driving method according to claim 2, wherein the preset charge data comprises a preset amount of voltage values; and the precharge signal comprises voltage signal of a preset amount of clock cycles.

4. The display driving method according to claim 3, wherein the preset amount is 4.

5. The display driving method according to claim 1, wherein at the start of frame scanning, the steps before acquiring preset charge data comprise:
acquiring a frame scanning 1st signal; and
determining the start of frame scanning when the frame scanning 1st signal is high level.

6. The display driving method according to claim 1, wherein the display driving method further comprises:
outputting a frame scanning 2nd signal after the precharge for the display pixels on the preset row signal line is completed; and
successively outputting scan driving signal to all the row scan signal lines and outputting charge signal when the frame scanning 2nd signal is high level so as to successively charge the display pixels on all the row signal lines.

7. The display driving method according to claim 6, wherein the display driving method further comprises:
at the time of successively outputting scan driving signal to all the row scan signal lines, outputting scan driving signal to the row signal line spaced apart from current row signal line by preset lines while outputting scan driving signal to current row signal line.

8. A display driving device comprising:
a data obtaining module for obtaining preset charge data at the start of frame scanning;
a precharge control module for precharging display pixels on preset row signal line in accordance with acquired preset charge data; and
a charge control module for successively charging the display pixels on all the row signal lines after the precharge for preset row signal line is completed, and precharging the display pixels on the signal line of the row spaced apart from current row signal line by preset rows while charging the display pixels on the signal line of current row.

9. The display driving device according to claim 8, further comprising a scan driving module and a data driving module; the precharge control module being further set to convert acquired preset charge data to precharge signal in accordance with preset polarity control signal, cause the scan driving module to output scan driving signal to preset row signal line, and cause the data driving module to output converted precharge signal to column signal line so as to precharge the display pixels on the preset row signal line.

10. The display driving device according to claim 9, wherein the preset charge data comprises a plurality of voltage values, and the precharge signal comprises voltage signal of clock cycle whose amount is the same as that of the voltage values.

11. The display driving device according to claim 10, wherein the preset charge data comprises 4 voltage values.

12. The display driving device according to claim 8, wherein the data obtaining module is set to obtain preset charge data when the frame scanning 1st signal is high level.

13. The display driving device according to claim 12, wherein the frame scanning 2nd signal will be outputted after the precharge control module completes the precharge for the display pixels on the preset row signal line.

14. The display driving device according to claim 13, wherein the charge control module is set to successively charge the display pixels on all the row signal lines when the frame scanning 2nd signal is high level, and precharge the display pixels on the signal line of the row spaced apart from current row signal line by preset rows while charging the display pixels on current row signal line.

15. The display driving device according to claim 14, wherein the display driving device further comprises a scan driving module and a data driving module; the charge control module is set to cause the scan driving module to successively output scan driving signal when the frame scanning 2nd signal is high level, and cause the data driving module to output corresponding charge signal to successively charge the display pixels on all the row signal lines.

16. The display driving device according to claim 15, wherein the charge control module causes the scan driving module to output scan driving signal to signal line of current row and output scan driving signal to signal line of row spaced apart from current row signal line by preset rows.

17. The display driving device according to claim 8, wherein the preset number of rows is 4.

18. A display device comprising a display unit and a driving device for driving the display unit to display; the driving device comprising a time sequence controller, a data driving module and a scan driving module; the time sequence controller acquiring preset charge data, controlling the data driving module and the scan driving module in accordance with acquired preset charge data, and precharging the display pixels on preset row signal line at the start of frame scanning; controlling the data driving module and the scan driving module and successively charging the display pixels on all the row signal line after the completion of precharge for preset row signal line; and precharging the display pixels on row signal line spaced apart from current row signal line by preset rows while charging the display pixels on signal line of current row.

19. The display device according to claim 18, wherein the preset charge data is stored in the time sequence controller.

20. The display device according to claim 18, comprising a liquid crystal display device or an organic electroluminesence display device.
